(19) United States
(12) Patent Application Publication
(10) Pub. No.: US 2013/0184040 A1
(43) Pub. Date: Jul. 18, 2013

(54) SERVER DEVICE, NON-TRANSITORY COMPUTER-READABLE STORAGE MEDIUM, AND GAME SYSTEM

(71) Applicant: DeNA Co., Ltd., Tokyo (JP)

(72) Inventors: Shinichiro NONAKA, Tokyo (JP); Kei Tachibana, Tokyo (JP)

(73) Assignee: DeNA Co., Ltd., Tokyo (JP)

(21) Appl. No.: 13/723,082

(22) Filed: Dec. 20, 2012

(30) Foreign Application Priority Data
Dec. 20, 2011 (JP) 2011-278842

(51) Int. Cl. A63F 13/12

(52) U.S. Cl. CPC A63F 13/12
USPC 463/7; 463/42

(57) ABSTRACT

A server device according to the present invention is a server device that is configured to connect over a network to a plurality of user terminals that are used when users are playing a game, including: a storage section that stores a plurality of sets of replay information used for reproducing play images of the game played by the users with the user terminals; and a control section that, if a replay reproduction request is received from any one of the plurality of user terminals, extracts from the plurality of sets of replay information stored in the storage section a set of replay information conforming to a certain condition that defines a skill level of a user who played the game, the replay reproduction request requesting a reproduction of a play image of the game.

### CROSS-REFERENCE TO RELATED APPLICATIONS

The present application claims priority upon Japanese Patent Application No. 2011-278842 filed on Dec. 20, 2011, which is herein incorporated by reference.

### BACKGROUND

1. Technical Field

This invention relates to a server device, a non-transitory computer-readable storage medium, and a game system.

2. Related Art

A game system is known that is configured to allow users to play a game over a network by connecting over the network a server device and a plurality of user terminals that are used when the users are playing the game (for example, Japanese Laid-Open Patent Publication No. 2003-320170).

Although it is possible to recognize a user's strengths by looking at a game level or other status in such a game system, it is difficult to recognize in detail the skill level of a user. As a result, there is a demand to actually see a user's play image that demonstrates the skill level in a game.

### SUMMARY

The present invention has been made in view of the above-described situations, and it is an advantage thereof to specifically recognize the skill level of a user through an actual play image.

An aspect of the invention to solve the above problem is a server device that is configured to connect over a network to a plurality of user terminals that are used when users are playing a game, including:

a storage section that stores a plurality of sets of replay information used for reproducing play images of the game played by the users with the user terminals; and

a control section that, if a replay reproduction request is received from any one of the plurality of user terminals, extracts from the plurality of sets of replay information stored in the storage section a set of replay information conforming to a certain condition that defines a skill level of a user who played the game, the replay reproduction request requesting a reproduction of a play image of the game.

Other features of this invention will become apparent from the description in this specification and the attached drawings.

### BRIEF DESCRIPTION OF DRAWINGS

FIG. 1 is an example of an overall configuration of a game system 1 according to the present embodiment.

FIG. 2 is a block diagram of a functional configuration of a server device 10 according to the present embodiment.

FIG. 3 is a block diagram of a functional configuration of a user terminal 20 according to the present embodiment.

FIG. 4 is an example of a play image displayed in the user terminal 20.

FIG. 5 illustrates an example of a data structure of user information.

FIG. 6 illustrates an example of a data structure of card information.

FIG. 7 illustrates an example of a data structure of opposing character information.

FIG. 8 illustrates an example of a data structure of replay information.

FIG. 9 is a flow chart describing an operation example of the game system 1 according to the present embodiment.

### DESCRIPTION OF EMBODIMENTS

With the description and the accompanied drawings, at least the following matters will be apparent.

A server device that is configured to connect over a network to a plurality of user terminals that are used when users are playing a game, including:

a storage section that stores a plurality of sets of replay information used for reproducing play images of the game played by the users with the user terminals; and

a control section that, if a replay reproduction request is received from any one of the plurality of user terminals, extracts from the plurality of sets of replay information stored in the storage section a set of replay information conforming to a certain condition that defines a skill level of a user who played the game, the replay reproduction request requesting a reproduction of a play image of the game.

According to such a server device, a skill level of a user can be recognized in detail by reproducing an actual play image of the game which the user played.

The above server device may further include

the server device further comprises a communication section that transmits the extracted replay information over the network to the user terminal that has transmitted the replay reproduction request.

According to such a server device, an actual play image of the game which the user played can be reproduced in a user terminal.

In such a server device, it is acceptable that

the game played by the user is a battle game

that progresses by executing a predetermined game program, and

whose outcome is determined by a battle with an opposing character in a preset game progression unit;

the certain condition includes

that the user defeats the opposing character, and

that a number of battles performed in the game progression unit is less than a predetermined number;

the replay information includes information concerning the number of battles in which the user defeats the opposing character; and

when the replay reproduction request is received, the control section

determines whether the information concerning the number of battles conforms to the certain condition for each of the plurality of sets of replay information stored in the storage section, and

extracts the conforming replay information.

According to such a server device, a skill level of a user that has defeated an opposing character with a small number of battles can be recognized through the actual play image of a played battle game.

In such a server device, it is acceptable that

the certain condition includes that a parameter indicating a strength which is set to the opposing character is higher than a predetermined value;

the replay information includes opposing character information that includes the parameter of the opposing character that the user competed with; and

the control section determines whether the respective opposing character information of the plurality of sets of replay information conforms to the certain condition, and extracts the conforming replay information.

According to such a server device, a skill level of a user that has defeated an opposing character set with a high strength level can be recognized through the actual play image of a played battle game.

In such a server device, it is acceptable that

if specification information in which the user specifies the certain condition is received when receiving the replay reproduction request from the user terminal,

the control section extracts the replay information based on the specification information from the plurality of sets of replay information stored in the storage section.

According to such a server device, when reproducing a play image of a game played by a user, the skill level of that user can be specified.

In such a server device, it is acceptable that

the control section

generates, based on the extracted replay information, a play image that can be reproduced in the user terminal that has transmitted the replay reproduction request, and

distributes the generated play image over the network to the user terminal that has transmitted the replay reproduction request.

According to such a server device, a computing load required for replay reproduction can be reduced since the play image does not need to be reproduced in the user terminal.

A non-transitory computer-readable storage medium storing a program executed by a computer that is configured to connect over a network to a plurality of user terminals that are used when users are playing a game, the program causing the computer to execute a process, including:

storing in a storage section a plurality of sets of replay information used for reproducing play images of the game played by the users with the user terminals;

if a replay reproduction request is received from any one of the plurality of user terminals, extracting a set of replay information conforming to a certain condition by a control section from the plurality of sets of replay information stored in the storage section,

the certain condition defining a skill level of a user playing the game,

the replay reproduction request requesting a reproduction of a play image of the game; and

generating, based on the extracted replay information, a play image that can be reproduced in the user terminal that has transmitted the replay reproduction request.

According to such a program, a skill level of a user can be recognized in detail by reproducing an actual play image of the game the user played.

A game system in which a plurality of users play a game over a network, the system including:

an input section into which the plurality of users input an operation when the game is played;

a storage section that stores a plurality of sets of replay information used for reproducing play images of the game played by the users with the user terminals; and

a control section

that, if a replay reproduction request is received from any one of the plurality of user terminals, extracts from the plurality of sets of replay information stored in the storage section a set of replay information conforming to a certain condition that defines a skill level of a user who played the game, the replay reproduction request requesting a reproduction of a play image of the game, and

that generates, based on the extracted replay information, a play image that can be reproduced in the user terminal that has transmitted the replay reproduction request.

According to such a game system, a skill level of a user can be recognized in detail by reproducing an actual play image of the game the user played.

### Present Embodiment

### Configuration of Game System 1

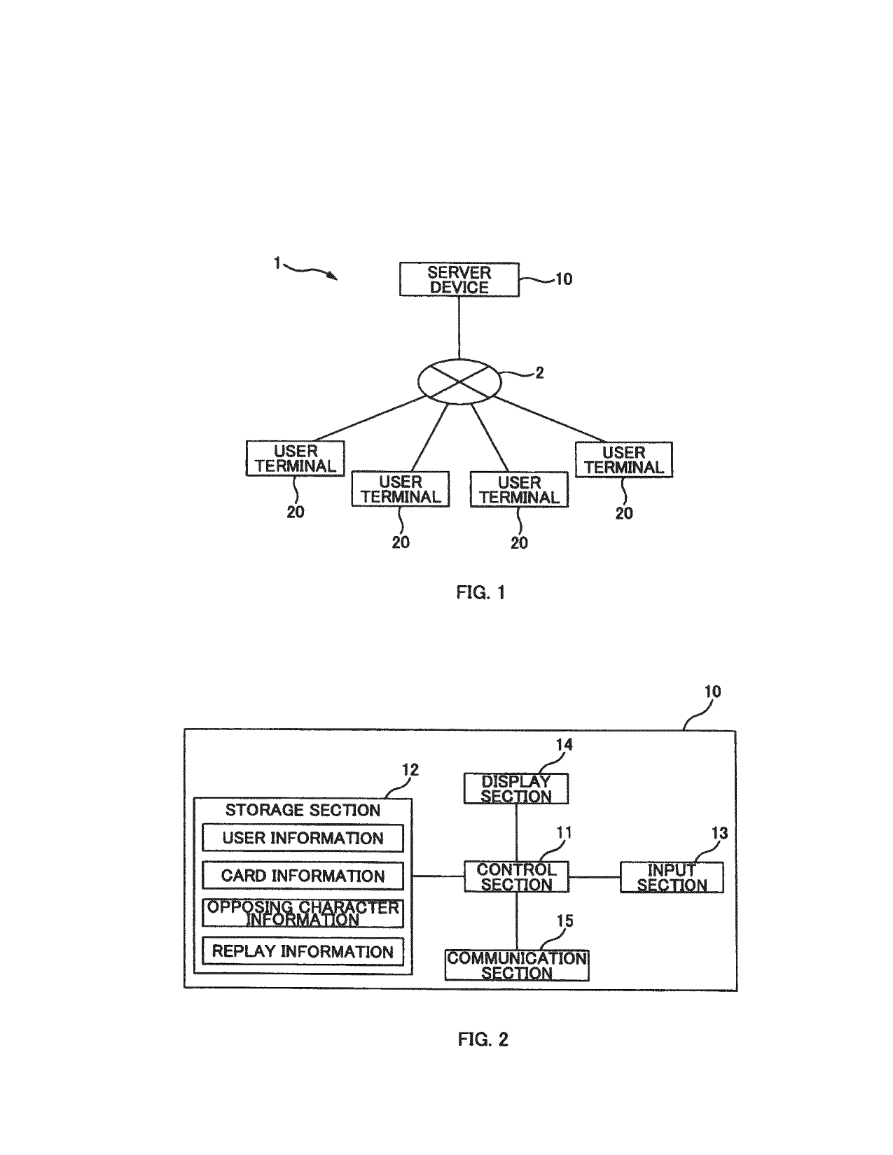

FIG. 1 is an example of an overall configuration of a game system 1 according to the present embodiment. The game system 1 of the present embodiment is a system that provides a game service over a network to a plurality of users. The game system 1 allows the users to play a game distributed over the network using the user's own game terminal. Also, the game system 1 encourages communication between a plurality of users by allowing the users to add other users to a friend list as friends and to play games and exchange messages with users who have become friends.

The game system 1 according to the present embodiment includes a server device 10 and a plurality of user terminals 20. The server device 10 and the user terminals 20 are each connected to a network 2 and are able to communicate with each other. The network 2 is, for example, the Internet, a local area network (LAN), or a value added network (VAN) established by Ethernet (R), a public switched telephone network, a radio communication network, or a mobile phone network.

The server device 10 is a computer used by an operator when managing and controlling the game service. The server device 10 is, for example, a workstation or personal computer and is able to distribute various types of information to the user terminals 20 in response to various commands (requests) transmitted from those user terminals 20. When a distribution request for game contents is received from a user terminal 20 used by a user playing a game, the server device 10 according to the present embodiment is able to distribute in accordance with the request the following game contents: a game program that is operable on the user terminal 20: a web page which is generated by a mark-up language (HTML and the like) suited to the standards of the user terminal and has linked image data related to the game; and the like.

The user terminal 20 is a computer used by a user when playing a game. The user terminal 20 may be, for example, a mobile telephone terminal, a smartphone, a personal computer, or a game device and the like. The user terminal 20 is able to send a distribution request for various types of information (e.g., game contents) related to the game to the server device 10 that is accessible over the network.

### Configuration of Server Device 10

FIG. 2 is a block diagram of a functional configuration of a server device 10 according to the present embodiment. The server device 10 according to the present embodiment includes a control section 11, a storage section 12, an input section 13, a display section 14, and a communication section 15.

The control section 11 is a unit that transfers data between the units and controls the entire server device 10. The control section 11 is realized by a central processing unit (CPU) executing a program stored in a certain memory. Specifically, the control section 11 has a function to execute various controls and information processes related to the game system 1 such as various processes to provide a game service and various processes to respond to requests from the user terminals 20.

The storage section 12 has a read only memory (ROM) and a random access memory (RAM): the ROM is a read-only storage region in which system programs for the server device 10 are stored, and the RAM is a rewritable storage region in which various types of data (flags and computed values used by the system program) generated by the control section 11 are stored and which is used as a work area for computing processes performed by the control section 11. The storage section 12 is realized, for example, by a non-volatile storage device such as a flash memory or a hard disk and the like. The storage section 12 is connected to the control section 11 through a bus. In accordance with commands from the control section 11, the data stored in the storage section 12 is looked up, read, and rewritten. The storage section 12 according to the present embodiment stores user information, card information, opposing character information, and replay information: the user information is information related to a user; the card information is information related to a game card used by the user; the opposing character information is information related to an opposing character; and the replay information is used when reproducing on the user terminal 20 a play image of the game played by the user. The various types of information are described below.

The input section 13 is a unit with which an operator inputs various types of data (e.g., the card, information or opposing character information described below), and is realized, for example, by a keyboard, a mouse, or a touchscreen.

The display section 14 is a unit which displays operating screens for the operator according to commands from the control section 11, and is realized, for example, by a liquid crystal display (LCD) and the like.

The communication section 15 is a unit for performing communication with the user terminals 20, and has a function as a reception unit for receiving signals and various data transmitted from the user terminals 20, and a function as a transmission unit for transmitting the signals and various data to the user terminals 20 in accordance with commands from the control section 11. The communication section 15 is realized, for example, by a network interface card (NIC) and the like.

### Configuration of User Terminal 20

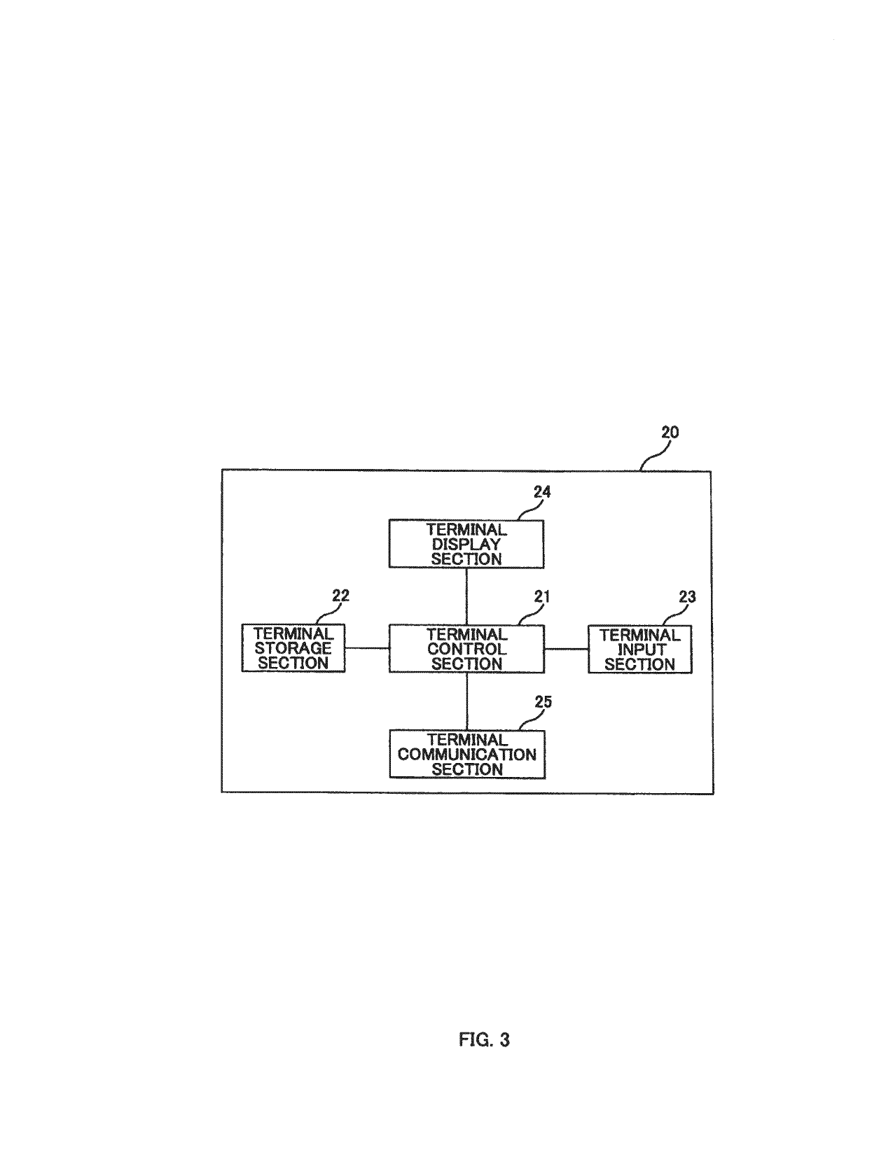

FIG. 3 is a block diagram of a functional configuration of a user terminal 20 according to the present embodiment. The user terminal 20 according to the present embodiment includes a terminal control section 21, a terminal storage section 22, a terminal input section 23, a terminal display section 24, and a terminal communication section 25.

The terminal control section 21 is a unit that transfers data between the units and controls the entire user terminal 20. The terminal control section 21 is realized by a central processing unit (CPU) executing a program stored in a certain memory. Specifically, the terminal control section 21 has a function to execute various controls and information processes related to the game system 1 such as various processes for accessing a game site, and various processes for sending requests to the server device 10.

The terminal storage section 22 has a read only memory (ROM) and a random access memory (RAM): the ROM is a read-only storage region in which system programs for the user terminal 20 are stored; and the RAM is a rewritable storage region in which various types of data (flags and computed values used by the system program) generated by the terminal control section 21 are stored and which is used as a work area for computing processes performed by the terminal control section 21. The terminal storage section 22 is realized, for example, by a non-volatile storage device such as a flash memory or a hard disk and the like. The terminal storage section 22 is connected to the terminal control section 21 through a bus. In accordance with commands from the terminal control section 21, the data stored in the terminal storage section 22 is looked up, read, and rewritten. In the present embodiment, the terminal storage section 22 records user IDs and the following game contents which are transmitted from the server device 10: game programs, game data and the like.

The terminal input section 23 is a unit with which the user performs various operations (game operations, text input operations, and the like), and is realized, for example, by an operating button or a touchscreen.

The terminal display section 24 is a unit for displaying a game screen (game play image) generated based on game information according to commands from the terminal control section 21, and is realized, for example, by a liquid crystal display (LCD) and the like.

The terminal communication section 25 is a unit that performs communication with the server device 10. The terminal communication section 25 has a function as a reception unit for receiving signals and various data transmitted from the server device 10, and a function as a transmission unit for transmitting the signals and various data to the server device 10 in accordance with commands from the terminal control section 21. The terminal communication section 25 is realized, for example, by a network interface card (NIC) and the like.

### Game Outline

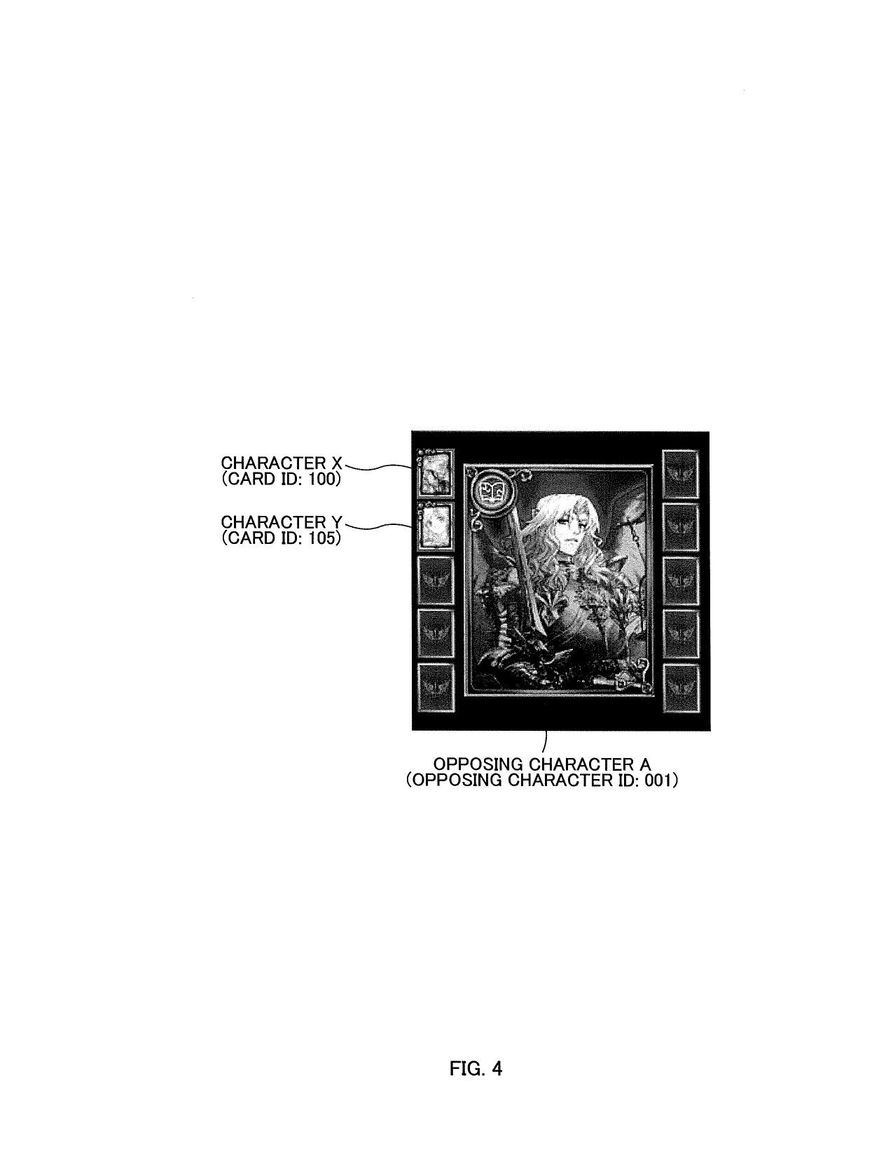

An outline of the game provided by the game system 1 according to the present embodiment will be described with reference to FIG. 4. FIG. 4 is an example of a game screen displayed on the terminal display section 24 in the user terminal 20.

The game system 1 according to the present embodiment is able to provide a battle game that determines an outcome by allowing a character selected by a user to battle with an opposing character. The user can battle with the opposing character alone in the battle game, or the user can participate in the battle game with help from another user added to a friend list. An outline of this game will be explained below.

First, the user selects a character to battle with the opposing character. In the present embodiment, the user can own a plurality of game cards in a virtual space in the game. The game cards each correlate with a game character. Thus, when the user selects a game card to be used in the battle from the game cards that the user owns, the character correlating with the selected game card is set as the character who battles with the opposing character. If the user participates with the help of another user added to the friend list, when the user selects a game card, it is possible to select a game card to be used for battling from the game cards owned by the other user. Without being limited to the other user added to the friend list, it is possible to select a character to be used for battling from game cards owned by another user not added to the friend list.

While playing the battle game, when a game card correlating with a character X and a game card correlating with a character Y are selected, the character X and the character are displayed in the game screen (top left) as illustrated in FIG. 4. The character X and the character Y then battle with an opposing character A displayed in the center of the game screen as illustrated in FIG. 4. In the present embodiment, the user can select up to a maximum of ten game cards to be used for battling when playing the battle game.

Next, a battle game process is performed in which the character selected by the user battles with the opposing character. An attack by the character selected by the user and an attack by the opposing character is established as one set, and the battle game is programmed so as to progress using the set of the attacks as a game progression unit. The game progression unit is called a “turn”. That is, a battle is performed in each turn in the battle game.

Specifically, when the user inputs a command to perform an attack, the user's character attacks the opposing character in accordance with the input command, and the opposing character performs a counter-attack to resist the attack. At this stage, one turn is finished. The battles are repeated a plurality of times as turn 2, turn 3, and so on until the outcome is determined. In the battle game, a user that gets the result of being victorious with a fewer number of turns (number of battles) is a user that demonstrates a correspondingly higher skill level in the game. A user who beats an opposing character set with a higher strength level is a user that demonstrates a correspondingly higher skill level in the game.

The outcome in the battle game process in the present embodiment is determined based on a life parameter (hit point parameter) set for each character. The battle game is programmed so that, in the battle game process, the value of the life parameter (hit point parameter) is reduced in accordance with attacks by an adversary and the character whose value of the life parameter (hit point parameter) reaches zero first is defeated.

When the battle game (one game unit) is finished by the outcome being determined in this way, the following kinds of information are recorded as the replay information: information related to the character of the user who battled; information related to the opposing character that the user battled with; and information related to the play history of the battle game. Thus, a reproduction (replay reproduction) of the play image performed by the user is made possible on the basis of the recorded replay information after the battle game is finished.

As described above, the game system 1 according to the present embodiment has not only a game process function for playing a game, but also a replay reproduction process function for reproducing play images of the game played by a user. This enables another user to reproduce a play image actually played by a certain user on the other user's user terminal 20. This makes it possible to recognize in detail the skill level of the user that played the game through the actual play image.

### Data Configuration

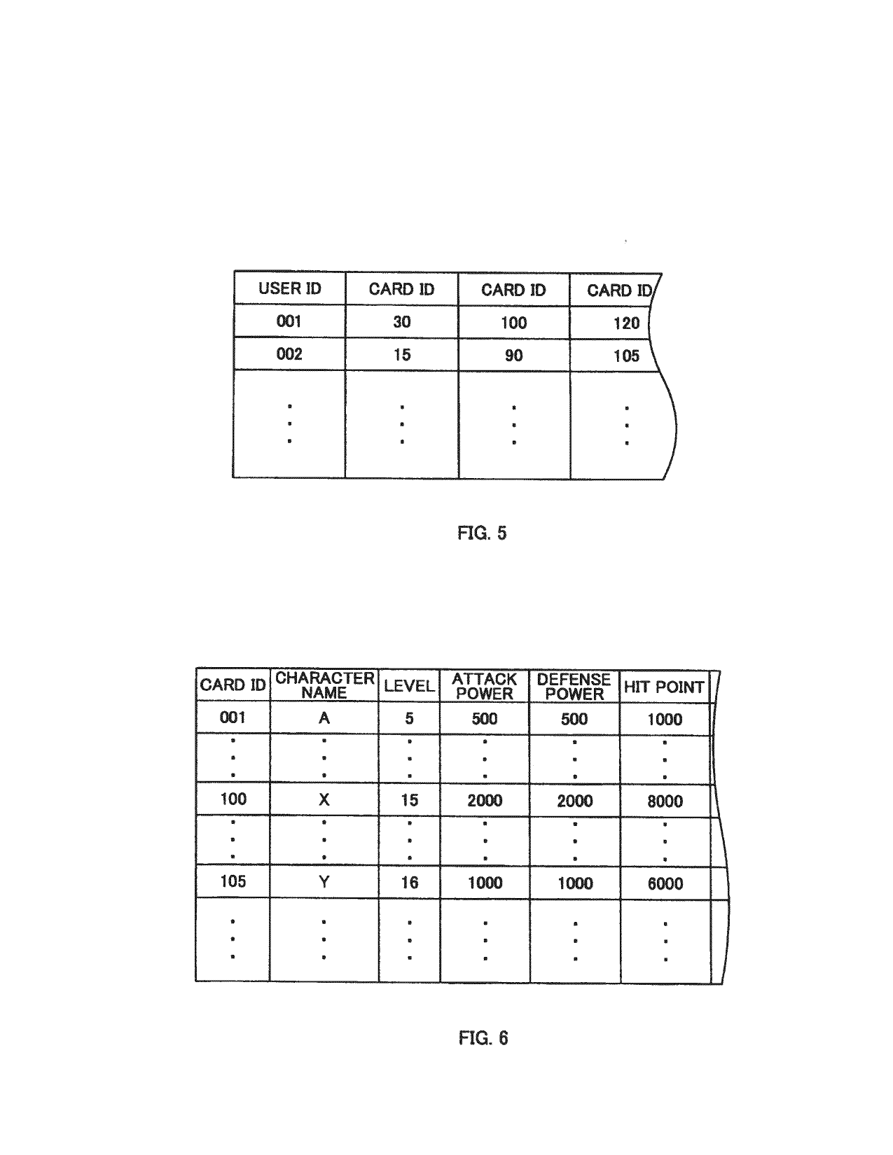

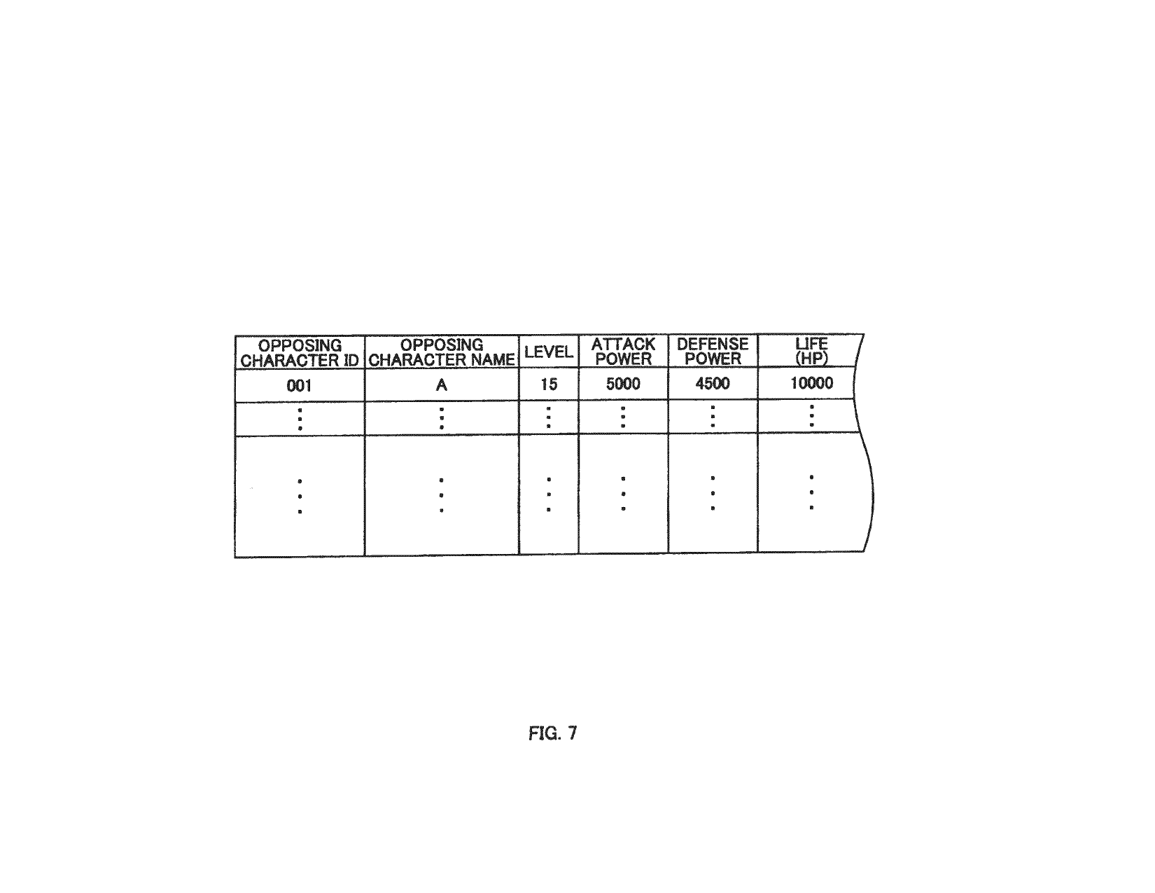

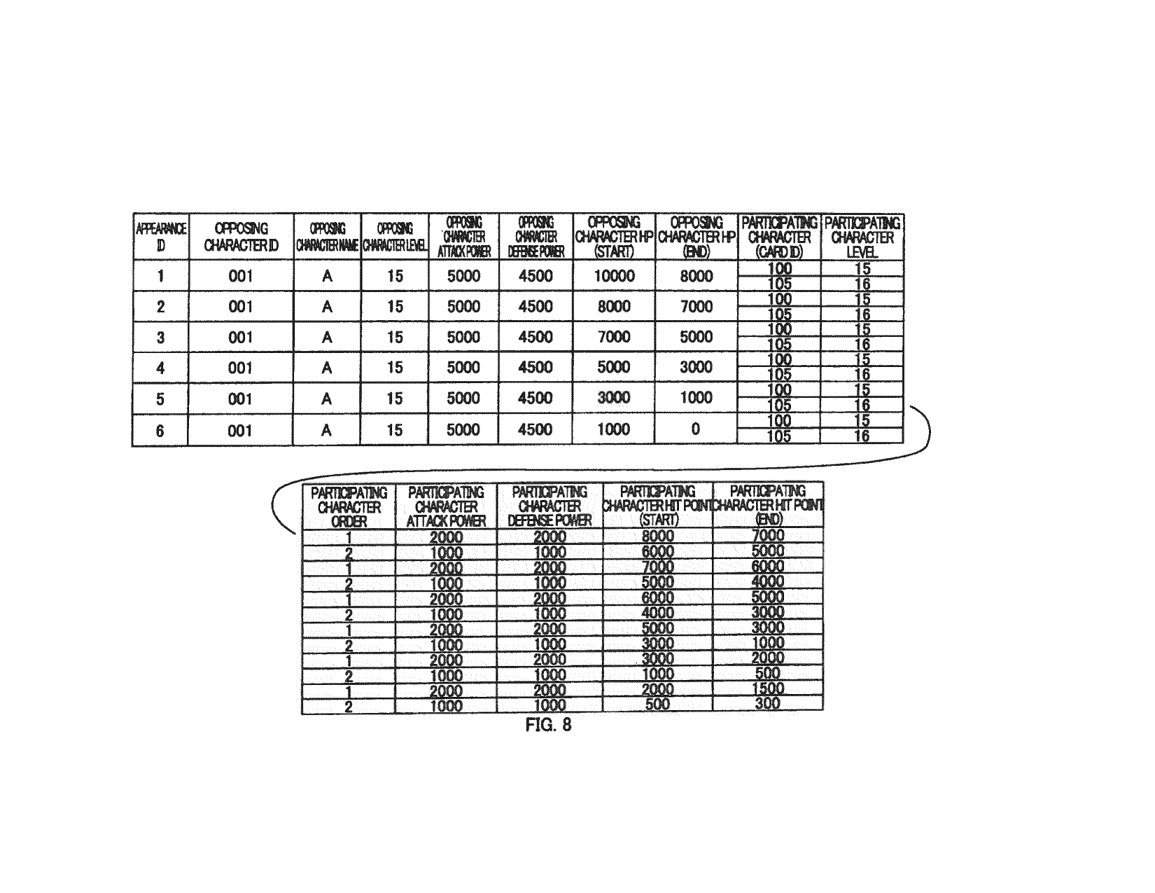

The various information used in the game system 1 of the present embodiment will be described with reference to FIGS. 5 to 8. FIG. 5 illustrates an example of a data structure of user information. FIG. 6 illustrates an example of a data structure of card information. FIG. 7 illustrates an example of a data structure of opposing character information. FIG. 8 illustrates an example of a data structure of replay information.

User information, card information, opposing character information, and replay information is stored in the storage section 12 in the server device 10 in the present embodiment. These types of information are used in the game system 1 when the battle game process to determine the outcome of the battle game is performed or when the replay reproduction process for reproducing a game scene that a user played is performed.

The user information includes: a user ID for identifying a user; and various information related to that user correlating with the user ID. For example, as illustrated in FIG. 5, a card ID for identifying a game card used in a battle game is included in the user information. That is, since the card ID correlates with the user ID, the user corresponding to the user ID is considered the owner of the game card that corresponds to the card. ID. Thus, when playing the battle game, the user can select a game card to use in the battle from the game cards that the user owns. When a user obtains a game card from the virtual space in the game, the user information is updated by newly correlating the card ID corresponding to the obtained game card and the user ID of that user. The game card is added to the game cards owned by that user.

The card information includes: a card ID for indicating the type (character type) of the game card to be used in the virtual space in the game; and various information related to the card correlating with the card ID. For example, as illustrated in FIG. 6, the card information includes the name of the character correlating with the game card, the level of the character, and various types of parameters such as attack power, defense power, and hit point. When a game card to be used to battle with the opposing character is selected by the user while the battle game process is being performed, the card information (e.g., attack power) of the selected game card is reflected as a skill level set for the character corresponding to the selected game card. Thus, the outcome of the battle game is determined.

The opposing character information includes: an opposing character ID for identifying the opposing character; and various information related to the opposing character correlating with the opposing character ID. For example, as illustrated in FIG. 7, the opposing character information includes the opposing character name, the level of the opposing character, and various types of parameters such as attack power, defense power, and life (HP). When the battle game process is performed, the opposing character information (e.g., attack power) is reflected as a skill value set for the opposing character. Thus, the outcome of the battle game is determined.

The replay information includes: information related to the character of the user playing the battle; information related to the opposing character the user is battling with; and information related to the play history of the battle game. The replay information is information used when reproducing the play image of the game played by the user. The battle game in the present embodiment is configured as one game having a plurality of turns. Thus, the replay information includes: an appearance ID for identifying each turn in one game; and various information for replay reproductions associated with the appearance ID. For example, as illustrated in FIG. 8, the replay information includes: the opposing character ID for identifying the type of opposing character whom the user is battling with; the name of the competing opposing character; the level of the battling opposing character; the attack and defense powers of the battling opposing character; the life (HP) of the opposing character at the start of the battle; the life (HP) of the opposing character at the end of the battle; an attack pattern of the opposing character with respect to the character; the card IDs of the game cards corresponding to the characters participating in the battle; the levels of the characters participating in the battle; the order of the characters participating in the battle; the attack and defense powers of the characters participating in the battle; the hit points of the characters participating in the battle at the start of the battle; and the hit points of the characters participating in the battle at the end of the battle. The game system 1 of the present embodiment is able to accurately reproduce the play image of the game played by the user by performing the replay reproduction process based on the replay information. The replay information is recorded individually for each one game of the battle game.

An example of operations of the game system 1 according to the present embodiment using the various information will be explained below in detail.

### Operation of Game System 1

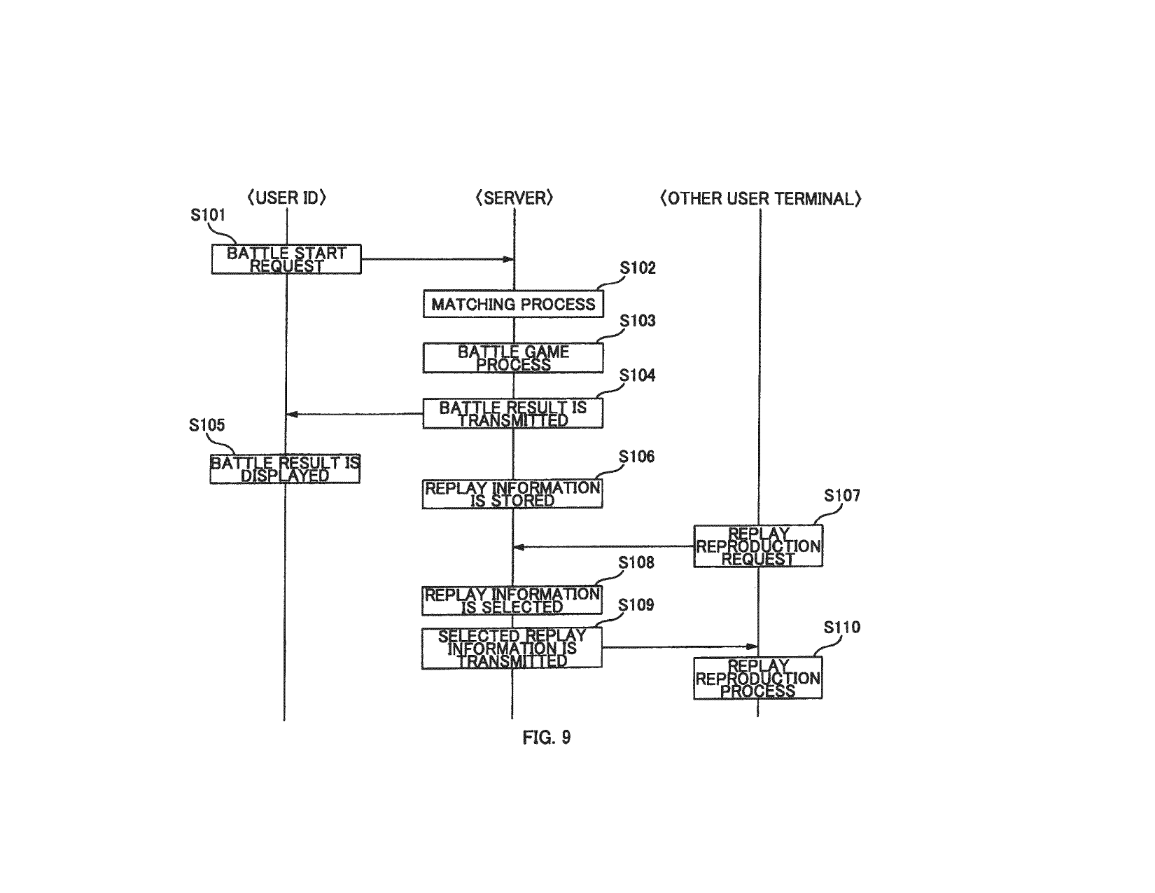

FIG. 9 is a flow chart describing an operation example of the game system 1 according to the present embodiment. At least the battle game process to determine the outcome in the battle game and the replay reproduction process to reproduce the play image of the game played by the user are executed in the operations of the game system 1 of the present embodiment.

First, a web page accessed by the user for starting the battle game is displayed on the terminal display section 24 of the user terminal 20 and the battle game is started by the user operating the terminal input section 23. Specifically, when the terminal control section 21 receives an input signal to start the battle from the terminal input section 23, the terminal control section 21 sets the user ID to a command for starting the battle game (battle start request) and transmits the command to the server device 10 through the terminal communication section 25 (S101).

The user at this time can select a game card, in other words, select a character correlating with the game card to be used in the battle game. The character selected by the user becomes the character to battle with the opposing character in the virtual space in the game. Therefore, when the character is selected by the user operating the terminal input section 23, the terminal control section 21 reads the card ID of the game card corresponding to the selected character from the terminal storage section 22 and transmits the read card ID and the user ID to the server device 10 through the terminal communication section 25.

Next, when the server device 10 receives the battle start request which is provided with the user ID, the server device 10 performs a matching process to determine a combination of an opposing character and a participating character that participates in the battle with the opposing character (S102).

Specifically, the control section 11 first selects any opposing character from the plurality of characters registered in the opposing character information illustrated in FIG. 7. In the present embodiment, it is assumed that the opposing character A (opposing character ID: 001) is selected. Next, the control section 11 refers to the user information illustrated in FIG. 5. And, from the card IDs correlating with the user ID which is included in the battle start request, the control section 11 selects a card ID that matches the card ID of the game card selected by the user. In the present embodiment, the user (user ID: 001) playing the battle game is assumed to select the game card (card ID: 100) of the character X that the user owns (see FIGS. 5 and 6). The character X corresponding to the game card selected by the user is determined as the participating character. In the matching process, when the participating character is determined, a character corresponding to a game card owned by another user can be added as a participating character. In the present embodiment, the control section 11 specifies another user (user ID: 002) that is a friend of the user (user ID: 001) by referring to the friend list. The control section 11 then selects any of the game cards from the plurality of game cards owned by the other user (user ID: 002) by referring to the user information illustrated in FIG. 5. That is, any of the card IDs is selected among the plurality of card IDs correlating with the user ID: 002. It is assumed that the game card (card ID: 105) of the character Y is determined as the participating character (see FIGS. 5 and 6). Thus, in the present embodiment, the character X (card ID: 100) and the character Y (card ID: 105) cooperate and the battle game against the opposing character A is started in the virtual space in the game.

Although a case of matching a combination of participating characters and opposing characters has been described in step S102, the step is not limited as such. For example, only matching of the participating characters may be performed. In this case, if the user satisfies a certain battle requirement, the user may select an opposing character whom the user can play against. Moreover, an opposing character to play against may be previously set before the matching process is performed. When determining the participating characters, the character to be determined is not limited to one owned by another user added to the friend list. That is, a character to be used in the battle can be selected from game cards owned by another user not added to the friend list.

Next, when the combination of the participating characters and the opposing character is determined, the server device 10 performs the battle game process to determine the outcome of the battle game based on the characters (S103).

Specifically, based on the card information illustrated in FIG. 6, the control section 11 acquires parameters such as the levels, attack powers, defense powers, and hit points which are set for the participating characters. Also, based on the opposing character information illustrated in FIG. 7, the control section 11 acquires parameters such as the level, attack power, defense power, and life (HP) which are set for the opposing character. The control section 11 calculates the amount of damage which the participating characters give to the opposing character, based on the parameters such as the level, attack power and defense power which are set for the participating characters. Then, the control section 11 reduces, in accordance with the damage, the life parameter set for the opposing character. Similarly, the control section 11 calculates the amount of damage which the opposing character gives to the participating characters, based on the parameters such as the level, attack power and defense power which are set for the opposing character. Then the control section 11 reduces, in accordance with the damage, the hit point parameters set for the participating characters. The control section 11 repeats this calculation at each turn. When the control section 11 assesses that the life parameter has reached zero first, the control section 11 determines that the opposing character is defeated (the participating characters have won). When the control section 11 assesses that the hit point parameters have reached zero first, the control section 11 determines that the participating characters are defeated (the opposing character has won).

Next, the server device 10 transmits to the user terminal 20 that transmitted the battle start request the battle result (information for displaying on the user terminal 20 an image of the participating characters defeating the opposing character or an image of the participating characters losing to the opposing character) (S104). For example, the server device 10 consecutively transmits to the user terminal 20 one frame of image data previously arranged in an order for performing a video display on the user terminal 20 as the battle result.

The user terminal 20 then receives the battle result transmitted from the server device 10 and displays the battle result on the display section 24 (S105). For example, the battle result is displayed as a video by consecutively displaying the image data which is consecutively transmitted from the server device 10 according to the previously determined order a single frame at a time. In the present embodiment, the battle game is performed by the character X (card ID: 100) and the character (card ID: 105) cooperating to battle with the opposing character A (opposing character ID: 001). Therefore, as illustrated in FIG. 4, the play screen which shows the battle scenes is displayed in a state where the opposing character A (opposing character ID: 001) is arranged at the center of the screen and the character X (card ID: 100) and the character Y (card ID: 105) are arranged at the top left of the screen. As a result, the user can recognize from the play image the battle results of the battle game played by the user.

Although a case in which the control section 11 of the server device 10 performs the battle game process has been described in step S103, the present embodiment is not limited as such. For example, the terminal control section 21 of the user terminal 20 may execute the battle game process. In this case, the user terminal 20 may transmit the information related to the play history of each turn to the server device 10 after the battle game process is executed.

Next, when the server device 10 performs the battle game process (corresponding to a single game) for the battle game, the server device 10 registers the following information as the replay information: the information related to the participating character that battled (participating characters (card IDs), levels of participating character, attack powers, defense powers, and the like); the information related to the opposing character that battled (opposing character ID, level of opposing character, attack power, defense power, and the like); and the information related to the play history of the battle game (appearance ID and various data correlating with the appearance ID) (S106). Specifically, the control section 11 registers the various data for each turn as the replay information as illustrated in FIG. 8. In this way, the contents of the battle performed in the battle game can be reproduced afterward due to the recording of the data.

The battle contents of one turn will be described in detail based on various data related to one turn (appearance ID: 1) of the replay information illustrated in FIG. 8.

First, the card IDs 100 and 105 are registered in the “participating character (card ID)” column, and the opposing character ID: 001 is registered in the “opposing character ID” column. With reference to FIGS. 6 and 7, it can be seen that, in the battle of this one turn, the character X (card ID: 100) and the character Y (card ID: 105) are set as the participating characters, and that the opposing character A (opposing character ID: 001) is set as the opposing character.

Moreover, various data of the card information illustrated in FIG. 6 are registered to the “participating character level” column, the “participating character attack power” column, and the “participating character defense power” column. That is, in the battle of this one turn, the character X (card ID: 100) is set to level 15, attack power 2000, and defense power 2000, and the character Y (card ID: 105) is set to level 16, attack power 1000, and defense power 1000.

An arrangement number is registered to the “participating character order” column, in the battle of this one turn, the play image is displayed in which the character X (card ID: 100) is arranged first (see FIG. 4, first row from top left) and the character Y (card ID: 105) is arranged second (see FIG. 4, second row from top left). The partnership between the participating characters can be modified by specifying the order of these characters by the user. If the partnership is good, the attack powers of the participating characters are increased.

Moreover, various data of the opposing character information illustrated in FIG. 7 are registered to the “opposing character level” column, the “opposing character attack power” column, and the “opposing character defense power” column. in the battle of this one turn, it can be seen that the opposing character A (opposing character ID: 001) is set to level 15, attack power 5000, and defense power 4500.

in the battle of this one turn, the competing character X (card ID: 100) and the character Y (card ID: 105) carry out an attack against the opposing character A (opposing character ID: 001). As a result, when looking at the “Opposing character HP (start)” and the “Opposing character HP (end)” columns, the life parameter (HP) is reduced from 10,000 points (start) to 8,000 points (end) due to the damage sustained by the opposing character A.

Conversely, when looking at the “participating character hit point (start)” and the “participating character hit point (end)” columns, the hit point parameter of the character X (card ID: 100) is reduced from 8,000 points (start) to 7,000 points (end), and the hit point parameter of the character Y (card ID: 105) is reduced from 6,000 points (start) to 5,000 points (end), as a result of the opposing character A (opposing character ID: 001) carrying out an attack on the character X (card ID: 100) and the character Y (card ID: 105).

Compare the “participating character hit point (end)” column and the “opposing character HP (end)” column within the replay information illustrated in FIG. 8. It can be seen that, when the battle of turn 6 (appearance ID: 6) is finished, the “participating character hit point (end)” column shows 1,500 points and 300 points remaining, and the “opposing character HP (end)” column shows that the HP reaches zero point first. That is, it can be seen that the outcome of the battle is determined at turn 6 and that the opposing character A has been defeated. In this way, the various data of each turn is registered in the replay information until the “opposing character HP (end)” column reaches zero; the various data becomes information related to the number of turns (number of battles) when the opposing character was defeated.

The replay information registered in this way is used when reproducing (when a replay is generated) the play image of the game played by the user on the user terminal 20. Thereby, the battle contents of each turn are accurately reproduced.

Next, another user different from the user accesses a web page for starting the replay reproduction, and the web page is displayed on the terminal display section 24 of the other user terminal 20. The replay reproduction is started by the operation of the terminal input section 23. Specifically, when the terminal control section 21 receives an input signal to start the replay reproduction from the terminal input section 23, the terminal control section 21 sets the user ID to a command (replay reproduction request) for starting the replay reproduction, and transmits the command to the server device 10 through the terminal communication section 25 (S107).

Next, when the server device 10 receives the replay reproduction request set with the user ID, the server device 10 performs processing to extract, from the plurality of sets of replay information stored in the storage section 12, a set of replay information conforming to a certain condition that defines the skill level of the user playing the battle game (S108). The certain condition in the present embodiment is that the opposing character is defeated in turns equal to or less than a predetermined number of turns (e.g., defeating the opposing character in three turns or less). By setting such a certain condition, it is possible to specifically recognize the skill level of the user through the actual play image since the replay information for reproducing the play image of a user who has demonstrated the skill level determined by the requirement is extracted. Additionally, a requirement that the level (a parameter indicating strength) of the battling opposing character be higher than a predetermined value (e.g., defeating an opposing character with a level of 30 or higher) may be included in the certain condition. Replay information for reproducing the play image of the user who demonstrates an even higher skill level in the battle game can be extracted.

The server device 10 then transmits the replay information extracted as described above to the other user terminal 20 that transmitted the replay reproduction request over the network (S109).

In the above step S107, the user is able to specify the certain condition such as the number of turns, the opposing character level, and the like. The terminal control section 21 transmits the replay reproduction request in which specification information specified by a user is set as the certain condition. On the other hand, when the replay reproduction request with the specification information is received from the user terminal 20, the server device 10 retrieves from the storage section 12 the replay information matching the certain condition specified based on the specification information. Then, the server device 10 transmits the matching replay information to the other user terminal 20. This allows users to specify a skill level of the user and to see a play image (video) that they want to replay reproduce.

The other user terminal 20 then performs a replay reproduction process to reproduce the play images that the users played based on the transmitted replay information (S110). The terminal control section 21 generates the play images by each frame in order according to the received replay information and consecutively displays the play images on the terminal display section 24. Consequently, since the play images (video) in which battle scenes of each turn are accurately reproduced are displayed on the other user terminal 20, the skill levels of the users can be recognized in detail through the actual play images. For example, when the replay reproduction is performed for a battle game in which the character X (card ID: 100) and the character Y (card ID: 105) cooperate to battle with the opposing character A (opposing character ID: 001), the opposing character A (opposing character ID: 001) is arranged at the center of the screen and the character X (card ID: 100) and the character Y (card ID: 105) are arranged at the top left of the screen, as illustrated in FIG. 4. In the foregoing state, the play images (replay images) in which the battle scenes are staged are displayed on the terminal display section 24.

Although a case in which the server device 10 transmits the extracted replay information to the other user terminal 20 has been described in step S109, the present embodiment is not limited as such. For example, based on the extracted replay information, the control section 11 of the server device 10 may perform a process of generating a play image that can be reproduced in the other user terminal 20 that has transmitted the replay reproduction request. The control section 11 then transmits the generated play image to the other user terminal 20 over the network instead of transmitting the extracted replay information. As a result, a computing load required for replay reproduction can be reduced since the play image does not need to be generated in the user terminal 20.

### Other Embodiments

The present embodiment facilitates understanding of the present invention and does not intend to limit the interpretation of the present invention. Variations and modifications may be made in accordance with the spirit and scope of the present invention and equivalents thereof are included in the present invention. In particular, embodiments described below are to be included in the present invention.

The game system may be configured as another embodiment so that the user and another user added to the friend list or another user not added to the friend list can cooperate in real time to play the battle game. The configuration of the other embodiment is the same as the above embodiment, but the operations thereof may be modified as follows.

In a matching process (corresponding to step S102 in FIG. 9 of the above embodiment) according to the other embodiment, it is possible to perform matching of the following characters: a character selected from the game cards owned by the user; and a character selected from the game cards owned by another user added to the friend list or from another user not added to the friend list. Each of the users can select a maximum of ten game cards (characters) to be used in the battle from the his/her own game cards (characters).

In a battle game process (corresponding to step S103 in FIG. 9 in the above embodiment) according to another embodiment, an outcome is determined between the opposing character who is the battle adversary and each of the characters selected from the game cards owned by the users. Here, the users are able to battle with the opposing character by taking turns. Specifically, when the user inputs a command to carry out an attack, the user's character attacks the opposing character in accordance with the input command and the opposing character performs a counter-attack to resist the attack, thus completing one turn. Next, the other user inputs a command to perform an attack and the subsequent second turn is completed in the same way as described above. Battles are repeated a plurality of times increasing the number of turns until the outcome is determined.

In this way, the users are able to actually cooperate and battle (perform cooperative play in real time) by using the character game cards owned by the users.

What is claimed is:

1. A server device to which a plurality of user terminals are connected over a network, the user terminals being used when users are playing a competitive game whose outcome is determined by a battle with an opposing character in a preset game progression unit, comprising:
a storage section that stores a plurality of sets of replay information,
the replay information being used for reproducing play images of the game played by the users with the user to terminals, and
the replay information including information concerning a number of matches
which is performed in the game progression unit, and
in which a user defeats the opposing character; and
a control section that, if a replay reproduction request is received from any one of the plurality of user terminals, extracts from the plurality of sets of replay information stored in the storage section a set of replay information conforming to a condition that the opposing character is defeated in the matches the number of which is equal to or less than a predetermined number,
the replay reproduction request requesting a reproduction of a play image of the competitive game.

2. A server device to which a plurality of user terminals are connected over a network, the user terminals being used when users are playing a competitive game whose outcome is determined by a battle with an opposing character, comprising:
a storage section that stores a plurality of sets of replay information,
the replay information being used for reproducing play images of the game played by the users with the user terminals, and
the replay information including a parameter indicating a strength which is set to the opposing character; and
a control section that, if a replay reproduction request is received from any one of the plurality of user terminals, extracts from the plurality of sets of replay information stored in the storage section a set of replay information conforming to a condition that the parameter of the opposing character is higher than a predetermined value,
the replay reproduction request requesting a reproduction of a play image of the competitive game.

3. A server device according to claim 1, wherein
the server device further comprises a communication section that transmits the extracted replay information over the network to the user terminal that has transmitted the replay reproduction request.

4. A server device according to claim 1, wherein
if specification information in which the user specifies the condition is received when receiving the replay reproduction request from the user terminal,
the control section extracts the replay information based on the specification information from the plurality of sets of replay information stored in the storage section.

5. A server device according to claim 1, wherein
the control section
generates, based on the extracted replay information, a play image that can be reproduced in the user terminal that has transmitted the replay reproduction request, and
distributes the generated play image over the network to the user terminal that has transmitted the replay reproduction request.

6. A non-transitory computer-readable storage medium storing a program executed by a computer to which a plurality of user terminals are connected over a network, the user terminals being used when users are playing a competitive game whose outcome is determined by a battle with an opposing character in a preset game progression unit, the program causing the computer to execute a process, comprising:
storing in a storage section a plurality of sets of replay information,
the replay information being used for reproducing play images of the game played by the users with the user terminals, and
the replay information including information concerning a number of matches
which is performed in the game progression unit, and
in which a user defeats the opposing character;
if a replay reproduction request is received from any one of the plurality of user terminals, extracting a set of replay information conforming to a condition by a control section from the plurality of sets of replay information stored in the storage section,
the condition being one that the opposing character is defeated in the matches the number of which is equal to or less than a predetermined number,
the replay reproduction request requesting a reproduction of a play image of the competitive game; and
generating, based on the extracted replay information, a play image that can be reproduced in the user terminal that has transmitted the replay reproduction request.

7. A non-transitory computer-readable storage medium storing a program executed by a computer to which a plurality of user terminals are connected over a network, the user terminals being used when users are playing a competitive game whose outcome is determined by a battle with an opposing character, the program causing the computer to execute a process, comprising:
storing in a storage section a plurality of sets of replay information,
the replay information being used for reproducing play images of the game played by the users with the user terminals, and
the replay information including a parameter indicating a strength which is set to the opposing character;
if a replay reproduction request is received from any one of the plurality of user terminals, extracting a set of replay information conforming to a condition by a control section from the plurality of sets of replay information stored in the storage section,
the condition being one that the parameter of the opposing character is higher than a predetermined value,
the replay reproduction request requesting a reproduction of a play image of the competitive game; and
generating, based on the extracted replay information, a play image that can be reproduced in the user terminal that has transmitted the replay reproduction request.

8. A game system in which a plurality of users play over a network a competitive game whose outcome is determined by a battle with an opposing character in a preset game progression unit, the system comprising:
an input section into which the plurality of users input an operation when the game is played;
a storage section that stores a plurality of sets of replay information,
the replay information being used for reproducing play images of the game played by the users with the user terminals, and
the replay information including information concerning a number of matches
which is performed in the game progression unit, and
in which a user defeats the opposing character; and
a control section
that, if a replay reproduction request is received from any one of the plurality of user terminals, extracts from the plurality of sets of replay information stored in the storage section a set of replay information conforming to a condition that the opposing character is defeated in the matches the number of which is equal to or less than a predetermined number,
the replay reproduction request requesting a reproduction of a play image of the competitive game, and
that generates, based on the extracted replay information, a play image that can be reproduced in the user terminal that has transmitted the replay reproduction request.

9. A game system in which a plurality of users play over a network a competitive game whose outcome is determined by a battle with an opposing character, the system comprising:
an input section into which the plurality of users input an operation when the game is played;
a storage section that stores a plurality of sets of replay information,
the replay information being used for reproducing play images of the game played by the users with the user terminals, and
the replay information including a parameter indicating a strength which is set to the opposing character; and
a control section
that, if a replay reproduction request is received from any one of the plurality of user terminals, extracts from the plurality of sets of replay information stored in the storage section a set of replay information conforming to a condition that the parameter of the opposing character is higher than a predetermined value,
the replay reproduction request requesting a reproduction of a play image of the competitive game
that generates, based on the extracted replay information, a play image that can be reproduced in the user terminal that has transmitted the replay reproduction request.
